(19) United States
(12) Patent Application Publication
(10) Pub. No.: US 2011/0113121 A1
(43) Pub. Date: May 12, 2011

(54) Method And System For Operating A Primary PC From A Remote Pseudo-mobile PC

(76) Inventor: Amit Sarkar, Scarsdale, NY (US)

(21) Appl. No.: 13/007,987

(22) Filed: Jan. 17, 2011

Related U.S. Application Data
(63) Continuation-in-part of application No. 10/715,090, filed on Nov. 17, 2003, now abandoned.
(60) Provisional application No. 60/452,330, filed on Mar. 6, 2003.

(51) Int. Cl. G06F 15/16

(52) U.S. Cl. 709/218

(57) ABSTRACT

The method and system allows a remote user to virtually access and use software in his/her primary processing unit from remotely located mobile input/output device which can comprise a display, keyboard, mouse, and a transceiver. The only function of the mobile input/output device is to send input signals to the remotely located primary processing unit where they are processed and transmitted back to the mobile input/output device for display and use by the user. Input sent from the mobile input/output device to the primary processing unit is in the form of raw, unprocessed electronic signals. The mobile input/output device uses computing power of the primary processing unit; the CPU, applications, files and services of the primary processing unit to process the electronic signals. The mobile input/output device needs only very limited power, and does not require its own software and associated hardware to duplicate data processing or storage functions.

### CROSS REFERENCE TO RELATED APPLICATIONS

This application is a continuation-in-part application of non-provisional application No. 10/715,090 titled “Method and Apparatus for Operating a Primary PC from a Remote Pseudo-mobile PC” filed on Nov. 17, 2003, which claims the benefit of U.S. provisional application No. 60/452,330, filed on Mar. 6, 2003 in the United States Patent and Trademark Office.

The specifications of the above referenced applications are fully incorporated herein by reference in their entirety.

### BACKGROUND

1. Field

The method and system disclosed herein relates generally to computer networking, and more particularly to a new method and system for transmitting information, for example input signals from a mobile device to a user's primary PC such as a desktop PC for processing and then transmitting the processed information, for example output signals from the primary PC back to the mobile device, thus enabling the user to operate on the primary PC remotely from the mobile device.

2. Description of the Related Art

Local area networks (LANs) normally consist of nodes interconnected by physical telecommunications channels such as coaxial cable, twisted pair wire or fiber optics. Currently wireless LANs, the nodes of which are not connected by means of a physical channel, are being more widely used. Communication between these wireless LANs are normally by infrared (IR) or radio waves. A primary benefit of using wireless LANs is that a physical connection, i.e., cabling, is not required. This is particularly useful for mobile nodes such as laptop and notebook computers, personal digital assistant (PDA) and the like. If appropriately equipped with a suitable wireless adapter which includes a transmitter, receiver and a modem, mobile nodes can move around and still remain connected to the network, provided the nodes do not move out of range of a wireless radio tower.

Normally, to establish a connection between a notebook PC, a desk top PC and a LAN, a router can be used. The Network Operating System (NOS) of the desktop PC is provided with a built in router program connected to the Network Operating System on the LAN. Data in the form of information packets from the NOS of the notebook PC destined for either the NOS of the desktop PC or the NOSs on the LAN is first received by the router program on the NOS of the desktop PC. Based on the destination information contained in the data packet, the router will either send the data packet to the NOS of the desktop PC or to NOSs on the LAN.

Another method of establishing a connection between a notebook PC, a desk top PC and a LAN is with the use of a three way bridge. With this method, the NOS of the desktop PC is directly connected to the three way bridge program on the desktop PC. The NOS of the notebook PC is connected directly to the same three way bridge program. The NOSs on the LAN are also connected directly to the same three way bridge program.

The main difference between the router and the three way bridge is that the router redirects data in the OSI (Open System Interconnection Standard) layer 3, i.e., the network layer; and the three way bridge redirects data in the OSI layer 2, i.e., the data link layer.

In those instances where there is only one notebook PC, one desktop PC and a LAN, the three way bridge is simple to set up and use.

At present, a powerful laptop computer with an Internet connection through an Internet Service Provider (ISP) approaches true mobile computing. However, in the U.S., the absence of a high capacity broadband wireless network, and limitations in processing power of hand-held PDA devices for example, Blackberry®, i-Phone®, etc, compared to a computing system for example, a server, a PC, etc, have severely limited mobile computing functionality and, therefore, consumer acceptance as a substitute of a laptop PC. Some of the negative factors associated with mobile computing are the physical bulk of the laptop PC; extremely short battery life; and, very high capital and operating cost which, for a laptop, is typically double that of a desktop PC with similar power, features and functionality for hardware alone. Furthermore, lack of a secure connection is an issue for accessing confidential information, which can be compromised if allowed to leave the confinements of a secure environment. Therefore, secure full-service business and personal computing should be traded off to gain mobility, or data integrity must be compromised. However, neither of these options are attractive.

Mobile personal computers for example, Net book, i-Phone®, mobile laptop PC, etc, that are used today are separate from and different than the desktop computer located in the office or home. The desktop computer is usually considered by the user to be his/her primary PC. Typically, each user increasingly customizes his/her desktop PC with software and hardware adapted to perform specific desired functions. Therefore, when a user has a desktop PC, or any PC which the user considers to be his/her primary PC and a mobile laptop type of PC, any and all applications, functions, files and folders that are in the primary (desktop) PC is normally duplicated in the mobile laptop type of PC. Obviously, this duplication of applications and functions requires the user to again pay for all licensed software in use, ISP service, hardware, software, files (essentially the entire hard disc), network access, virus protection, firewall access (if applicable) and so on, to configure the laptop to be a perfect and complete substitute for the primary PC. In addition, practically any usage of the mobile laptop PC must normally be manually duplicated in the primary PC or, vice versa, if the laptop type of PC is to be a substitute for the primary (desktop) PC, since at every new keystroke a mobile laptop PC looses synchronization with the primary PC, even if a perfect synchronization is established at an initial stage.

Other currently available hand-held mobile devices that are less expensive than a laptop PC and are used to provide, in varying degrees, mobile computing services are, for example, advanced cellular phones, Palm Pilot, Window CE based devices, Blackberry® and i-Phone®. These devices have been generally accepted and have found wide use, but they all have one or more of the following disadvantages:

Limited functionality: for example, the only functionality Blackberry® provides besides voice communication is e-mail capability;

Limited data transfer capability: for example, a cell phone is not a data processing device; it is primarily a voice device capable of transmitting and receiving very limited data (text, graphics) and is not suitable for surfing the world wide web or executing performance intensive computations;

Limited range; some special purpose wireless mobile devices work only within a very short distance, such as within a hospital or an office building. In some devices, the limitation of range is comparable to the distance over which a cordless phone can transmit;

Unsupported by a robust national/international network: for example,., Wi-Fi hotspots provide expensive broadband internet connection only at a handful of locations. Moreover, a PC connected to internet uses internationally standardized protocols and formatting, resulting in the same user experience around the world irrespective of ISP used, but most mobile devices do not;

Inoperability and lack of interchangeability: none of these devices generally work with each other and/or with a desktop PC seamlessly;

Inflexibility: most of the devices require slavery to proprietary software and hardware; consumers are forced to frequently pay for “upgrades” that improve performance very little;

High cost: the cost is relatively high regardless of how severely limited the functionality or availability may be; and,

Relatively short battery life which requires frequent and inconvenient recharging; dramatic improvement in battery life is unlikely if heavy “processing” continues to be performed at the mobile device itself.

Furthermore, existing mobile computing technologies fall in two broad categories: (a) “pushing” selected pre-authorized data files from a secure server into an “intelligent” mobile device for processing and local storage (e.g. Citrix®, Blackberry®, etc.) and (b) “pulling” downloadable data from a remote server on public Internet or private corporate Intra-net (e.g. i-Phone, Netbook). Both of these computing technologies carry unacceptable security risks that may compromise data. For example, an e-mail sent to a Blackberry® user is electronically transmitted to the user's device. Data files attached in the email may be at risk of being compromised (e.g. a confidential memo as an attachment on Blackberry®).

Therefore, none of the presently available mobile devices can be used as a complete, fully functional substitute for a primary or desktop PC which has permanently stored on its hard disk, all of the users files and software. Clearly, what is needed is method and system which allows a user to securely operate remotely his/her own primary or desktop computer at home or office, or remote Information System, from a mobile, hand held, lightweight (“dumb”) terminal which can include a display, keyboard and a pointing unit.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and system discloses herein relates to conducting complete virtual computing sessions using a mobile input/output device, without having to either push compressed executable files with .EXE or .COM extension, and/or download data files, from a secure environment on to a mobile device. The mobile input/output device accesses a primary processing unit remotely for conducting the virtual computing sessions without program or data files ever leaving the primary processing unit. The user is provided a view of display screen of the primary processing unit. The user is also able to hear audible outputs provided by the primary processing unit. Therefore, user is aware of operations/computations that can be visually and/or audibly represented and the user can view and/or hear the output of such computations/operations. Furthermore, the mobile input/output device comprises one or more input/output peripherals and transmits user inputs captured from the input devices directly to the primary processing unit. The user uses the mobile input/output device to remotely access the primary processing unit. The primary processing unit receives the input, processes the received input and obtains an output. The output is one of a view of processed data, creation of a file, execution of a command, etc. The primary processing unit then stores the output data files securely within a local storage device and transmits only audio-visual signals representing the output back to the mobile input/output device for transient display to the user. The primary processing unit comprises a virtual session application. The virtual session application creates the virtual presence of the user in the primary processing unit.

The primary processing unit authorizes the user to conduct one or more operations during the virtual computing session, exactly as pre-configured. The primary processing unit authenticates the user prior to performing one or more of the pre-authorized operations. After authentication, the user provides an input to the mobile input/output device through one or more input units of the mobile input/output device. The input provided by the user is a digital translation of actions and analog inputs of the user, captured by the input units of the mobile input/output device. The input units of the mobile input/output device translate the user input from analog to digital. It should be noted that the mobile input/output device exchanges only peripheral input/output information during the virtual computing sessions and the information exchanged between the primary processing unit and the mobile input/output device is in the form of user inputs and audio-visual output signals only, and not in the form of output data files.

The mobile input/output device comprises peripheral hardware such as a display unit, one or more input units, a processing unit, a transceiver module and a speaker. The display unit is for example an LCD display. The LCD display also comprises a touch sensitive interface and receives user inputs provided through a stylus or touch. Apart from the touch sensitive LCD display, the mobile input/output device further comprises keyboard and a pointing unit. The transceiver in the mobile input/output device is a commercially available universal transceiver, which is integrated with the peripheral hardware units of the mobile input/output device. The transceiver module couples the primary processing unit to the remotely located primary processing unit, in a two way communication over any existing or third-party commercial network.

The transceiver module is in two way communication with the remote primary processing unit through any available wireless carrier network or a landline based internet service. Examples of such communication networks comprise a cellular network, a wireless LAN network, a Wi-Fi connection, and global networks, such as the public switched telephone network and/or the Internet Cloud. The mobile input/output device converts the user input into electronic signals, suitable for transmission over the communication network. In one embodiment, the transceiver module receives the user input directly from the input units and converts the user input into electronic signals. The user input provided to the mobile input/output device represents, for example, a command that the user intends to transmit to the primary processing unit; a change in position of a cursor, corresponding to a movement of a pointing device; a keystroke; etc.

The primary processing unit receives the electronic signals transmitted by the mobile input/output device. The virtual session application running within the primary processing unit translates the received electronic signals into system input signals, effectively providing a semblance that the system input signals were generated by inputs directly provided by a user physically operating the primary processing unit via peripherals directly connected to the primary processing unit. The system inputs are machine readable by CPU(s) of the primary processing unit. The system input signals issue instructions to the CPU(s) of the primary processing unit to manipulate, process, and store data at the primary processing unit. In one embodiment, the data manipulated and processed by the primary processing unit is locally stored. In another embodiment, the data manipulated and processed is stored in a remote location accessible by the primary processing unit via a communication network. The primary processing unit utilizes resources accessible locally and resources accessible over the communication network to obtain and store the output. The resources comprise applications and/or software, system services, etc., locally available as wells as the resources accessible over the communication network comprising networked data centers, remote applications, etc.

The mobile input/output device utilizes the primary processing unit for remote processing and subsequent storage of output data. The remotely located primary processing unit processes all inputs received from the peripheral hardware of the mobile input/output device. The virtual session application translates the output into audio-visual signals and transmits only the audio-visual signals in real-time to the mobile input/output signals over the communication network. The mobile input/output device displays the visual signals on its display unit in real-time and additionally provides an audio output corresponding to the audio signals. The audio-visual signals represent processed information for user review. Furthermore, the audio-visual signals are transient signals and do not comprise either underlying executable data files, with .EXE or .COM extension or the processed output data files. The transient audio-visual signals also do not comprise compressed data files. Instead, the data files are safely stored in the primary processing unit. Therefore, the user can virtually access the primary processing unit and establish a complete virtual session controlled directly by the virtual session application of the primary processing unit. Therefore, the remote user's experience would be identical to having physical access to the primary processing unit, including access to the peripherals connected to the primary processing unit by cable in real-time, without any restriction to usability of the resources of the primary processing unit for performing the pre-authorized operations.

The mobile input/output device receives the audio-visual signals through the transceiver module and presents the received audio-visual signals as audio output, screen flashes, or a combination of both audio output and screen flashes through the display unit and/or the speaker. Therefore, the method described enables the user to virtually and securely access, and use local software, local services, local system resources, and network resources of said primary processing unit. This method and system disclosed herein allows the primary processing unit to create a virtual presence of the user at its periphery. Thus, the method and system disclosed herein avoids the need to compress and transmit executable program files, including those with .EXE or .COM extension, and/or any data files to the remote user's mobile input/output device. Therefore, the user can remotely access and perform pre-authorized operations on the primary processing unit using the virtual session application resident on the primary processing unit without having to compress and transmit data files or program files to the mobile input/output device. Thus, a user can virtually access a primary processing unit, a networked workstation or an entire robust multi-server information system from a remote location using the mobile input/output device. In one embodiment, such an information system is networked with the primary processing unit and the user can access the information system through the primary processing unit.

The mobile input/output device disclosed herein is unlike existing hand-held devices. The mobile input/output device does not comprise a local storage unit to store data files, user input, data files, output, etc. The mobile input/output device is therefore incapable of downloading and/or processing third-party software applications, executable files with .EXE or .COM extension, etc. The mobile input/output device is also incapable of downloading/processing/storing data files received from Internet, with or without user knowledge, such as malicious programs, bugs, viruses, cookies and such. The mobile input/output device only functions as a captive remote peripheral for the virtual session application running within the primary processing unit. The mobile input/output device comprises a client program. The client program coordinates with the virtual session application resident within the primary processing unit. The virtual session application acts a host program, responding to user requests received from the mobile input/output device. As stated above, the user input is in the form of a change in position of a cursor, corresponding to a movement of a pointing device; a keystroke; etc.

In one embodiment, the mobile input/output device executes pre-programmed instructions received from the virtual session application. In this embodiment, the mobile input/output device comprises an application specific integrated circuit or a light-duty microprocessor, and embedded memory unit comprising a basic kernel of an operating system. The kernel manages operations such as boot up, power management operations, and operations of the LCD display, keyboard, transceiver module, and establishing a communication link between the mobile input/output device and the virtual session application in the primary processing unit. The mobile input/output device and the primary processing unit have a captive-captor relationship, wherein mobile input/output device renders itself as a dedicated dumb terminal of the primary processing unit. Initially, the kernel of the operating system initiates communication with the virtual session application and the virtual session application transmits audio-visual signals representing an output of the primary processing unit.

The mobile input/output device is incapable of locally storing the visual signals or the audio signals received from the primary processing unit. The peripheral hardware of the mobile input/output device remotely accesses the primary processing unit and uses the computing power of the primary processing unit, along with the CPU, applications, stored files, resources, and services associated or connected to the primary processing unit through a network (LAN/WAN). Since the mobile input/output device utilizes the virtual session application within the primary processing unit to receive user inputs, process the received input and transmit audio-visual signals corresponding to the processed input, the mobile input/output device needs only limited computation power, primarily to process raw audio-visual signals for display and presentation to the user.

The mobile input/output device does not require its own hardware or software to duplicate data processing of the primary processing unit, for example, executable system files with a .EXE or .COM extension; locally store data, program or system files; etc. The data processing and storage operations are performed by the primary processing unit. In contrast, a PDA like Blackberry® must run a locally resident sophisticated e-mail program to “download” an e-mail data file from a remote server, “machine read” the email data file to display it on the screen in human readable form and store it locally within the device. In addition, the PDA needs locally resident software programs to open or view any attachment, e.g. Microsoft Office™ or Abode Acrobat Reader™, none of which is required by the mobile input/output device disclosed herein. The mobile input/output device operates only as a captive and remote terminal of the primary processing unit under the control of the virtual session application. The mobile input/output device utilizes all the available system resources virtually. The resources comprise licensed or previously downloaded applications, program or data files and services accessible by the primary processing unit.

If a display having a touch sensitive screen is used to provide input, depending on the function chosen, the use of a keyboard is unnecessary. For example, the keyboard is unnecessary when the user is required to use click functionality of a pointing unit, for example, a mouse. The pointing unit can be easily replaced by the touch screen. The method and system disclosed herein relates to method and system for providing virtual mobile computing sessions from a remote hand held, light weight “dumb” terminal. The mobile input/output device is neither a small PC nor can it process any data, except to simply process raw audio and visual signals into screen flash and speaker output. The mobile input/output device transmits inputs (keystrokes/mouse clicks) to a remote primary processing unit and receives only audio-visual signals for display to the user, without receiving the underlying system output. The system output for example, comprises data files, and executable files such as files having .EXE and .COM file extensions. The data files are not transmitted to the mobile input/output device. Instead, these files are stored in the primary processing unit since the mobile input/output device is incapable of downloading, “machine-reading” or storing the data files locally.

Most PC users customize their primary (desktop) computer to comprise information and software necessary to satisfy their computing needs. The mobile input/output device disclosed herein is a small, light weight, inexpensive, hand held dumb terminal which provides virtual access to a remotely located primary processing unit to provide comprehensive mobile computing capability to the user. The virtual session application in the primary processing unit essentially creates a virtual presence of the user at the primary processing unit, while concurrently using the captive mobile input/output device for the peripheral function such as audio-visual display. Due to the creation of the virtual presence of the user at the primary processing unit, the entire system functionality, for example, data processing, security protocol, utilization of system resources and services as well as permanent storage functions remain unchanged, just as previously configured on the primary processing unit, including such things as contact information, default browser, e-mail or firewall configuration and Internet preferences. Therefore, the primary processing unit can also continue to utilize multiple resources accessible over the local or wide area network and the resources within a network of servers of an entire information system and/or data centers. The primary processing unit may obtain user processed information and store the user processed information in appropriate locations for example, a third party Enterprise Resource Planning (ERP) application server, a company e-mail server, etc.

The method and system disclosed herein creates a secure processing and storage environment for sensitive data by negating the transmission of executable files and data files, including those containing .EXE and .COM extension and/or data files. Furthermore, since programs and data files do not leave the primary processing unit, the method and system disclosed herein avoids a security breach of the program and data files. Therefore, the method and system disclosed herein preserves the integrity of the data files safely stored in the permanent storage areas of the primary processing unit and/or accessible over a network of physically distributed servers hosted in data centers elsewhere. Furthermore, the method and system disclosed herein allows a remote user to virtually all system resources and services of the primary processing unit in real-time. The system resources and services include but are not limited to heavy-duty firewall, licensed applications and other subscription services, third-party enterprise applications like ERP, landline based fast Internet services exceeding 100 MB/sec, and enormous storage etc. These system resources and services are currently impossible to access remotely, or are unavailable for use without a duplicate license on existing hand-held wireless device such as i-Phone®, Blackberry®, Net book or i-Pad®.

Furthermore, programs or data files located inside a firewalled network resource are also not transmitted by the primary processing unit to the mobile input /output device since the mobile input/output device cannot read, store, process, copy or transmit any data file. Therefore, the programs or data files are not compromised, lost, copied, transmitted or subjected to unauthorized use.

The foregoing has outlined the present invention so that those skilled in the art may better understand the detailed description of the invention that follows. Additional features of the invention will be described in the detailed description of the invention. Those skilled in the art should appreciate that they can readily use the disclosed concept and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIGS. 1 and 2, when positioned with FIG. 1 located above FIG. 2, is a block diagram of a method in accordance with the principles of the present invention.

FIG. 3 is a schematic of a mobile input/output device having access to a primary processing unit according to the present invention.

FIG. 4 is another schematic of a mobile input/output device having access to the primary processing unit according to the present invention.

FIG. 5A schematically illustrates normal operation of the primary processing unit, when a user is physically operating on the primary processing unit using peripheral devices like display unit, keyboard and mouse physically connected by cable, or hardwired.

FIG. 5B illustrates a system for totally virtual session of a remote user operating on the primary processing unit using the mobile input/output device, all operations within the primary processing unit remaining unchanged and only input/output peripheral function being altered.

### DETAILED DESCRIPTION

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

The method and system disclosed herein provides a mobile input/output device for a remote user using to virtually access a primary processing unit and process data on the primary processing unit. The mobile input/output device functions as a captive mobile terminal of the primary processing unit and establishes a virtual session with the primary processing unit. The primary processing unit comprises a virtual session application which creates a virtual presence of a user of the mobile input/output device in the primary processing unit, thereby establishing the virtual session. The method comprises transmitting the user's input from the mobile input/output device to the primary processing unit to obtain output. The primary processing unit receives the input, processes the received input to obtain output, stores said output, and transmits audio-visual signals representing the output back to the mobile input/output device for transient display to the user.

The mobile input/output device comprises peripheral hardware such as a display with a touch sensitive interface, a keyboard and a built-in commercially available transceiver module suitable for transmission over third party carrier networks and/or public Internet. In an embodiment, the mobile input/output device may also comprise a USB interface and a user may plug-in a USB modem to transmit electronic signals and receive audio-visual signals. Examples of primary processing unit comprise a desk top personal computer (PC) and/or, a network server providing access to an entire information system.

The primary processing unit is, for example, a stand-alone computer or a dedicated server. The virtual session application is a proprietary application residing in the primary processing unit. The mobile input/output device communicates with the primary processing unit through the virtual session application. The virtual session application receives electronic signals from the mobile input/output device and controls transmission of audio-visual signals from the primary processing unit to the mobile input/output device. In one embodiment, the mobile input/output device comprises an application specific integrated circuit (ASIC) comprising a memory unit. The memory unit stores a client program which coordinates with the virtual session application resident within the primary processing unit. The virtual session application acts a host program, responding to user requests from the mobile input/output device. As stated above, the virtual session application also controls transmission of audio-visual signals from the primary processing unit to the mobile input/output device. In another embodiment, the client program is part of a basic kernel of an operating system embedded within the memory unit and supplements interaction of the operating system kernel with the virtual session application. The kernel of the operating system is stored in the memory unit of the ASIC. The kernel performs basic physical operations, such as booting up the mobile input/output device, power management operations, operations of the LCD display, keyboard, transceiver module, and establishing a communication link between the mobile input/output device and the virtual session application in the primary processing unit, in lieu of a standard operating system such as Microsoft Windows® or Windows Mobile®.

The mobile input/output device operates purely as a stateless captive peripheral terminal of the primary processing unit and is incapable of downloading, reading, processing, locally storing, copying, or transmitting data. The mobile input/output device is also incapable of executing programs or third party applications, including any files containing .EXE or .COM extensions. Therefore, neither the primary processing unit nor the virtual session application are required to compress and transmit executable files, data files, etc, regardless of whether the program files contains a .EXE or a .COM extension.

The primary processing unit pre-authorizes the user to conduct one or more operations during the virtual computing session. The primary processing unit authenticates the user prior to performing the pre-authorized operations. After authentication, the user provides an input to the mobile input/output device through one or more input units of the mobile input/output device. The input provided by the user is a digital translation of actions and analog inputs of the user, captured by the input units of the mobile input/output device. Analog user inputs comprise keystrokes made using the keyboard, cursor movements made using the pointing unit, audio inputs provided through a microphone, etc. The input units of the mobile input/output device translate the user input from analog to digital. It should be noted that the mobile input/output device exchanges only peripheral input/output during the virtual computing sessions and the information exchanged is only in the form of user inputs and audio-visual output signals.

The transceiver module is in two way communication with the remote primary processing unit through any available wireless carrier network or a landline based internet service. Examples of such communication networks comprise a cellular network, a wireless LAN network, a Wi-Fi connection, and global networks, such as the public switched telephone network and/or the Internet Cloud. The mobile input/output device converts the user input into electronic signals, suitable for transmission over the communication network. In one embodiment, the transceiver module receives the user input directly from the input units and converts the user input into electronic signals. The user input provided to the mobile input/output device represents, for example, a command that the user intends to transmit to the primary processing unit; a change in position of a cursor, corresponding to a movement of a pointing device; a keystroke; etc.

The mobile input/output device transmits the electronic signals to the primary processing unit. In one embodiment, the electronic signals are coded to minimize the possibility of errors and security breach during transmission. Examples of signal coding utilized comprise forward error correction, wavefront coding, etc. The coded electronic signal are transmitted using any available communication technology including Internet packet switching and/or wireless broadband third party carrier technology such as 3G, High-Speed Downlink Packet Access (HSDPA), Evolution—Data Only (EV-DO), Wireless Code Division Multiple Access (WCDMA), 4G etc., and land line based internet technologies including virtual private networks (VPN).

The primary processing unit receives the electronic signals from the mobile input/output device. The virtual session application running on the primary processing unit translates the electronic signals into system input signals. The system input signals provide computer executable instructions to the primary processing unit to perform tasks comprising data manipulation, data processing, and data storage. The system input signals are processed by the primary processing unit and an output is obtained in the form of data files, executable files, a visual or an audible output, collectively termed as output. The primary processing unit may utilize one or more resources to obtain the output. Examples of the resources accessible by the primary processing unit comprise database systems comprising relevant data required for obtaining the output, various software and services available within the local area network or intra-net or wide area network and/or data centers. The output is in the form of computer readable data files that can be stored in appropriate locations within one or more hard discs of the primary processing unit. The virtual session application translates the output into appropriate audio-visual signals interpretable by the user.

Although, the primary processing unit is normally hardwired to send the audio-visual signals to peripheral hardware physically connected or interfaced with the primary processing unit, the virtual session application of the method and system disclosed herein supersedes this functionality and instead, transmits the output audio-visual signals back to the remote user's mobile input/output device via the same third party carrier network. The virtual session application issues commands to the primary processing unit to disable input/output ports through which the input/output peripherals may be physically connected to the primary processing unit. The virtual session application functionally disconnects the input/output peripherals from the primary processing unit, even if the input/output peripherals are still physically connected by cables. The virtual session application simultaneously replaces them by the input/output peripherals of the mobile input/output device. In essence, the virtual session application creates a virtual presence of the remote user within the primary processing unit by translating user inputs received through the mobile input/output device directly into system input signals generated inside the primary processing unit and relaying the audio-visual signals corresponding to the output back to the remote user.

The data files in machine readable form, representing output, never physically leave the primary processing unit and are sent to appropriate locations in the storage disk(s) of the primary processing unit. The virtual session application in the primary processing unit transmits only the audio-visual signals to the mobile input/output device, without transmitting the underlying system output such as computer readable data files. In an embodiment, the audio-visual signals are transmitted to the mobile input/output device over a single communication channel and the mobile input/output device obtains audio and visual components by processing the audio-visual signals. In another embodiment, the primary processing unit sends the audio and visual components over separate communication channels, for example a narrow voice band channel and a data broadband channel. The mobile input/output device renders the visual component as screen flashes through the LCD display and renders the audio components as audio output through a speaker.

The method and system disclosed herein, therefore, utilizes a unique concept of creating a virtual presence of the remote user in the primary processing unit. Since the user can virtually access the data files in the primary processing unit, the virtual session application eliminates the need to send the data or program files. Furthermore, elimination of transmission of the data and program files also eliminates the need to compress and transmit large data files, executable file, and program files such as files with .EXE or .COM extensions themselves, compressed or otherwise. This enables the user to virtually use all the resources accessible by the primary processing unit.

The mobile input/output device disclosed herein is a “dumb” terminal of the primary processing unit and is a captive client of the virtual session application running in the primary processing unit. The mobile input/output device is incapable of downloading data files, machine reading data files and/or locally store the data files. The mobile input/output device avoids security risks since no data is transmitted outside the secure storage of the primary processing unit during virtual sessions of the remote user. The mobile input/output device is also incapable of downloading, reading or locally storing third party software or programs. Furthermore, the mobile input/output device is also incapable of downloading unauthorized programs for example, bugs, viruses, cookies, spyware etc., and/or carry out malicious program instructions contained therein, capable of corrupting the data stored in the primary processing unit or secretly transmitting data elsewhere. In contrast, mobile computing devices such as a mini-PC or PDA are capable of downloading data and executing locally resident programs. Therefore, these devices can also download, store and execute the unauthorized programs.

The term “primary processing unit” includes any computer, whether desktop or laptop which the user considers to be his/her main computer which has the software that the user is currently relying on to process the signals being transmitted by the mobile input/output device. The mobile input/output device and primary processing unit can be connected to each other via an existing fixed land line and/or wireless global communication network such as the Public Switched Telephone Network (PSTN) and the Internet “Cloud” (a global network of interconnected servers) in a secured manner. The mobile input/output device may also be connected to the primary processing unit utilizing networks such as a wireless carrier network, a cellular network, a wireless LAN network, a Wi-Fi connection, a Wi-Max connection, and a public “hotspot”.

In an embodiment, the application specific integrated circuit (ASIC) in the mobile input/output device captures user input through the input units and converts the user input into electronic signals suitable for transmission using the transceiver module. If the primary processing unit transmits the audio-visual signals, the ASIC in the mobile input/output device processes the audio-visual signals and obtains audio components and visual components. If the audio components and the visual components are transmitted over separate communication channels, the ASIC directly renders the audio and visual components on the display and speaker.

The mobile input/output device can be a light weight handheld device which is smaller and lighter than a laptop or tabletop personal computer (PC), which consists of a high performance video display, a compact thin keyboard and/or an on-screen keyboard, a pointing unit with the capability of being attached to other hardware units such as, for example, a printer, a fax machine, MP3 player, etc., via, for example, a USB module, infra-red remote or a Bluetooth application. The mobile input/output device can be designed to be powered by limited, specialized light-duty computing microprocessor.

In an embodiment, the basic kernel of the operating system comprises additional package files to interface with the virtual session application running on the primary processing unit and the transceiver module. The ASIC of the mobile input/output device runs device drivers of input units and output units such as keyboard, mouse, display screen, touch sensitive interface of the display screen, etc. The device drivers provide an interface between the input/output units of the mobile input/output device and the application specific operating system kernel. The application specific operating system kernel may also perform power management of batteries of the mobile input/output device to avoid an unexpected switch off of the mobile input/output device in the middle of a virtual computing session with the primary processing unit.

The mobile input/output device is neither a small personal computer (mini-PC) nor an intelligent mobile device. Rather, the mobile input/output device can be considered as a set of input/output peripherals, for example, a display unit having a touch sensitive interface, a keyboard, a pointing unit, a speaker, a microphone, a transceiver module, an application specific integrated circuit (ASIC), a memory unit, a kernel of an operating system stored in the memory unit, and a client program stored in the memory unit. The communication between the primary processing unit and the mobile input/output device is controlled by the virtual session application running on the primary processing unit. The mobile input/output device functions as the captive “dumb” terminal of a primary processing unit via the virtual session application. The mobile input/output device duplicates exactly what the user sees on a display unit physically connected to the primary processing unit, if the user is physically using the primary processing unit. The mobile input/output terminal transmits input provided by the user to the primary processing unit and receives audio-visual signals provided as output by the primary processing unit. The wireless two way communications can include other digital data transmission protocol and standards besides public switched telephone network (PSTN)/cellular protocol, such as wireless-fidelity (Wi-Fi) or another third party carrier network.

The commercially available universal transceiver module used in the mobile input/output device allows two-way communication between the primary processing unit and the mobile input/output device. The transceiver module allows transfer of electronic signals from the primary processing unit to the mobile input/output device and audio-visual signals from the primary processing unit to the mobile input/output device in a secure mode. The hardware within the mobile input/output device is adapted to run four layers of complementary software as described below:

Layer 1 is a translation layer between the mobile input/output device user interface and the underlying application specific operating system kernel in the memory unit of the ASIC. Layer 1 converts input provided by the user through the input peripheral units into electronic signals;

Layer 2 digitizes the input electronic signals for wireless transmission and may optionally code and encrypt the signals to minimize the possibility of errors in the transmission and enhance security;

Layer 3 converts signals and graphics into cellular transmission packets for public switched telephone network (PSTN) or another network such as Wi-Fi, third party wireless carriers etc.; and

Layer 4 transmits the cellular packets over an existing cellular data transmission network through the router.

The functions for transmitting audio-visual signals from the primary processing unit to the mobile input/output device, via the virtual access application, are the reverse of the functions for transmitting electronic signals from the mobile input/output device to the primary processing unit. Thus, functionally, during transmission to the primary processing unit, the mobile input/output device transmits electronic signals received from input peripheral units such as key board operation, mouse click, etc., through the transceiver module/modem to the primary processing unit. During transmission from the primary processing unit, the mobile input/output device receives the audio-visual signals from the primary processing unit through the transceiver module for display on the screen and rendering of audio output through the speaker of the mobile input/output device.

For the transmission of information through a cellular/public switched telephone network (PSTN), the signal packets are coded and encrypted to enhance security with Transport Layer Security (TLS) encryption protocol, secure socket layer (SSL) and secure Internet server connection protocol such as https://.

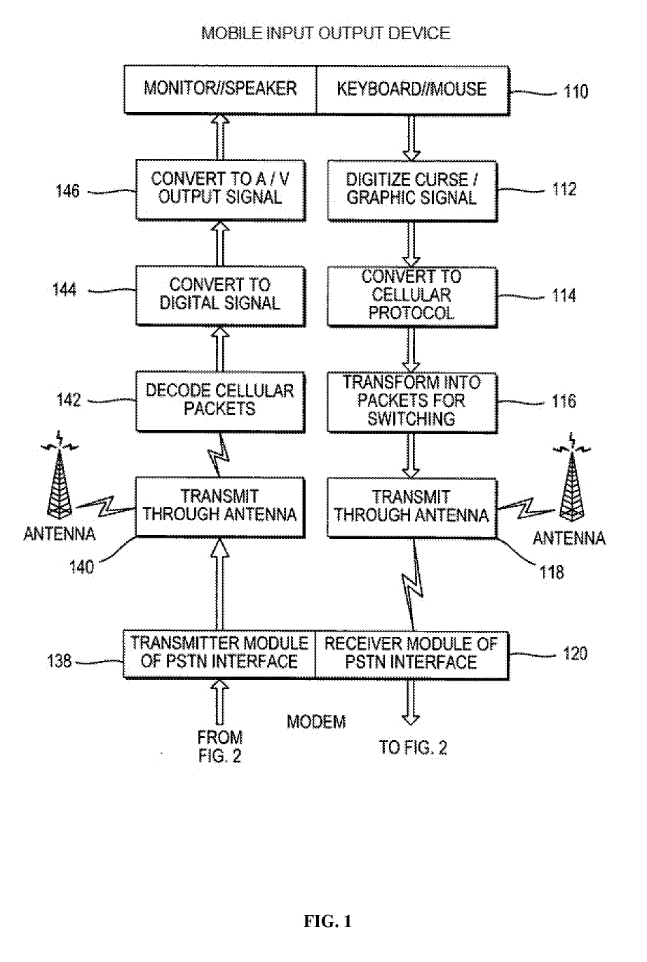

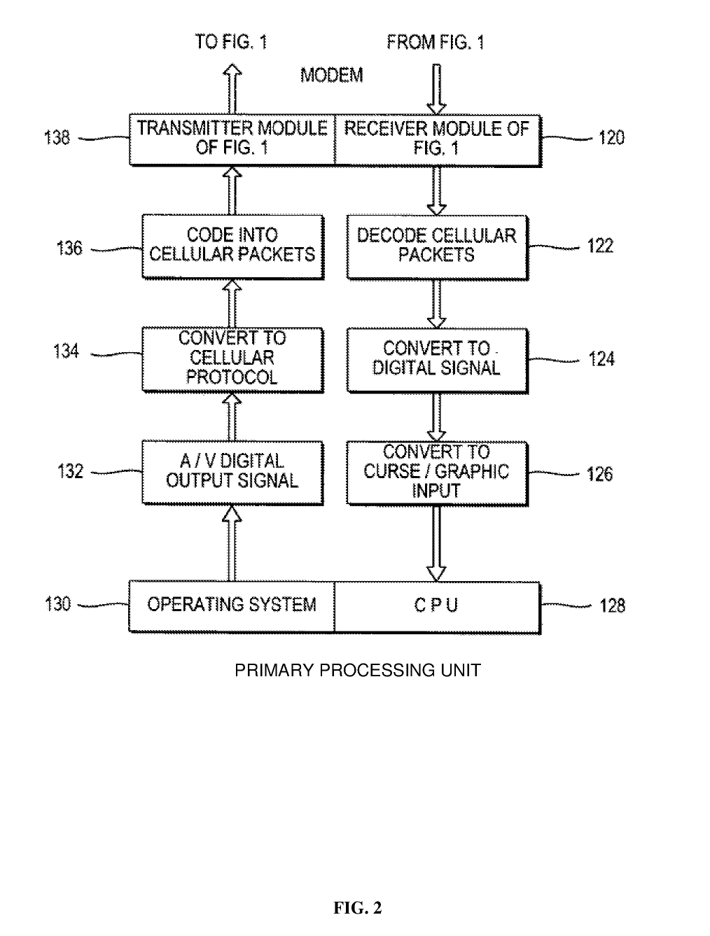

FIGS. 1 and 2 disclose a method for transmitting user input from a captive mobile input/output device to the primary processing unit via the virtual session application running on the primary processing unit. A user provides input to the mobile input/output device via the keyboard and/or a pointing unit, step 1, block 110. The user input represents at least a part of command or information the user intends to process using programs residing in the primary processing unit and/or resources accessible by the primary processing unit. At step 2, block 112, the input is digitized i.e., the input is converted into electronic signals. At step 3, block 114, it is converted to cellular protocol. At step 4, block 116, the user input in cellular protocol format is transformed into packets and are transmitted via radio waves, step 5, block 118 (and antenna), to a receiver module, step 6, block 120. Referring now to FIG. 2, from step 6, block 120, the signal is fed to block 122, step 7 where the received packets are decoded, and then, at step 8, block 124, where they are converted to digital signals. At step 9, block 126, the digital signals are converted to curser/graphic signals and fed to the Central Processor Unit 128 of the primary processing unit for processing via the operating system 130 of the primary processing unit. The curser/graphic signals are system input signals. The primary processing unit machine reads the system input signals and processes the electronic signals accordingly.

Thus, at this time, the user input that was entered into the mobile input/output device and transmitted to the remote primary processing unit is processed the same as if it were entered directly into the primary processing unit. No data processing was done by the mobile input/output device.

The electronic signals processed by the primary processing unit are now transmitted back to the mobile input/output device for viewing by the mobile input/output device user. At step 10, block 132, the electronic signals processed by the primary processing unit is converted into an audio-visual signal, while the actual computer data files are stored in the storage device within the primary processing unit, and then, at step 11, block 134, the audio-visual signals are converted to cellular protocol. At step 12, block 136, the cellular protocol signals are formatted into packets and forward to the transmit module, step 13, block 138, for transmission, via radio waves, step 14, block 140 (and antenna), for receipt by the mobile input/output device, step 15, block 142, which decodes the cellular packets. At step 16, block 144, the decoded cellular packets are converted to digital signals which are then converted to audio-visual signals at step 17, block 146. Thereafter, the audio-visual signals are fed to display/speaker of the mobile input/output device for viewing/listening by the user at a remote location.

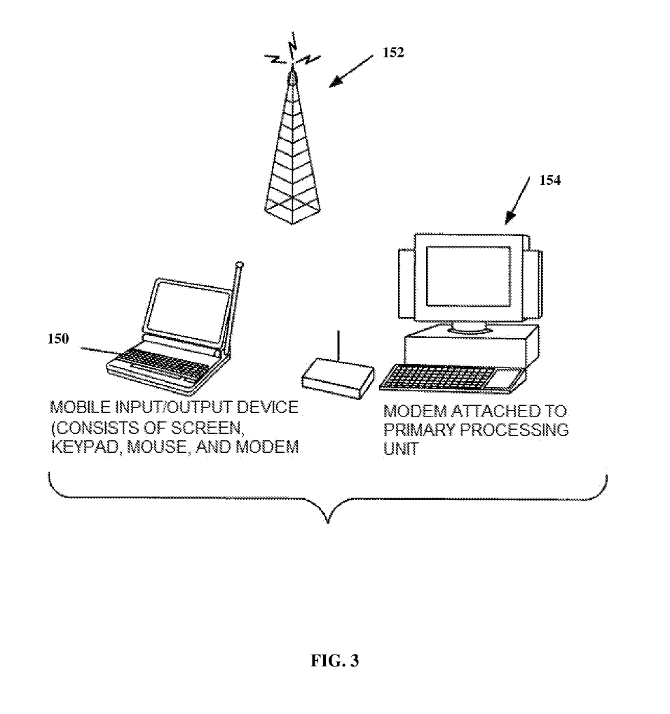

Referring to FIG. 3, there is shown a schematic of an arrangement for providing a mobile input/output device 150, consisting of a display, a keyboard, a pointing unit and a transceiver module for accessing, via radio waves, a primary processing unit 154, connected to an existing fixed line/wireless global communication network and having a modem for accessing the mobile input/output device 150. The radio waves are transmitted from the mobile input/output device 150 to a cellular tower 152 of the communication network and forwarded to the primary processing unit 154. Conversely, radio waves transmitted from the primary processing unit 154 are transmitted to the mobile input/output device 150 through the cellular tower 152.

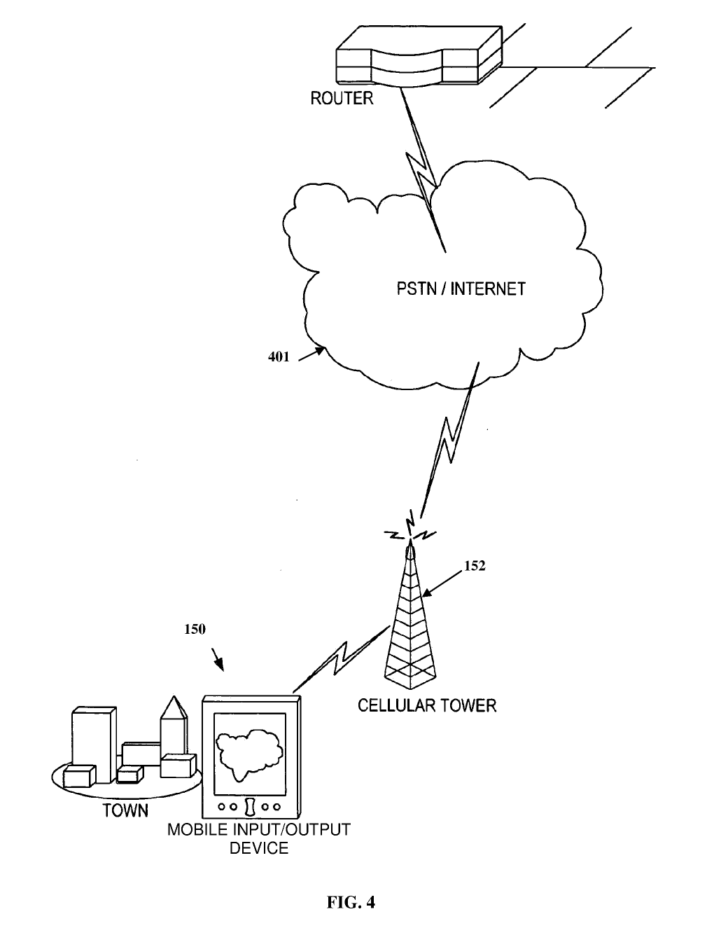

Referring to FIG. 4, there is shown a schematic of a small light weight handheld mobile input/output device 150 which consists of a display, a keyboard and a pointing unit together with a transceiver for communicating with a primary processing unit 154 via the global public switched telephone network (PSTN)/Internet Cloud 401. In an embodiment, the display of the mobile input/output device 150 comprises a touch sensitive interface and negates the need for a detachable keyboard.

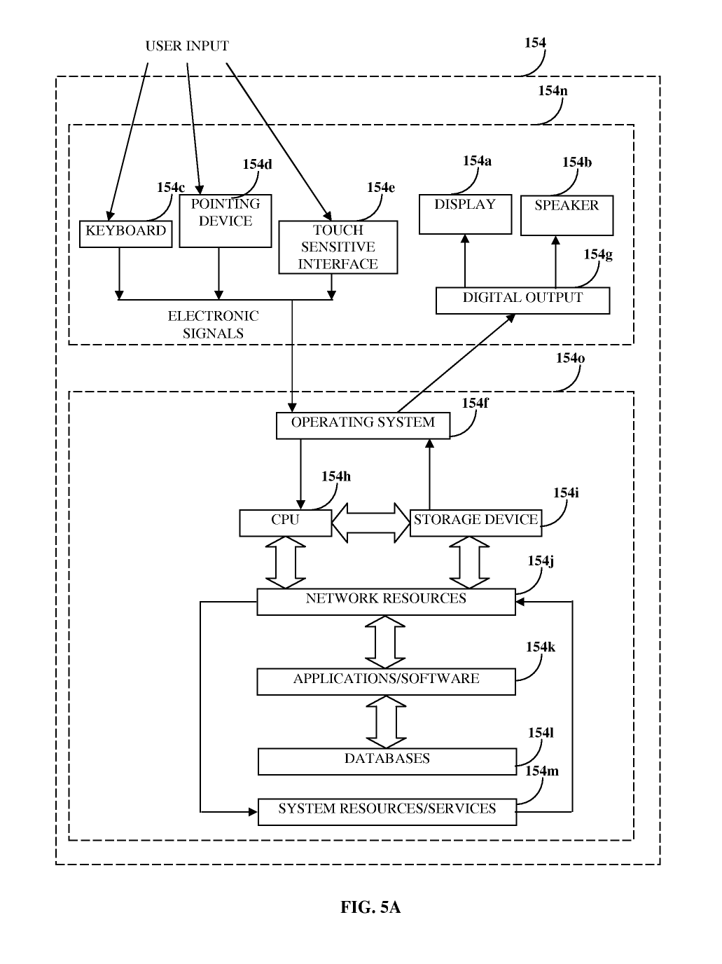

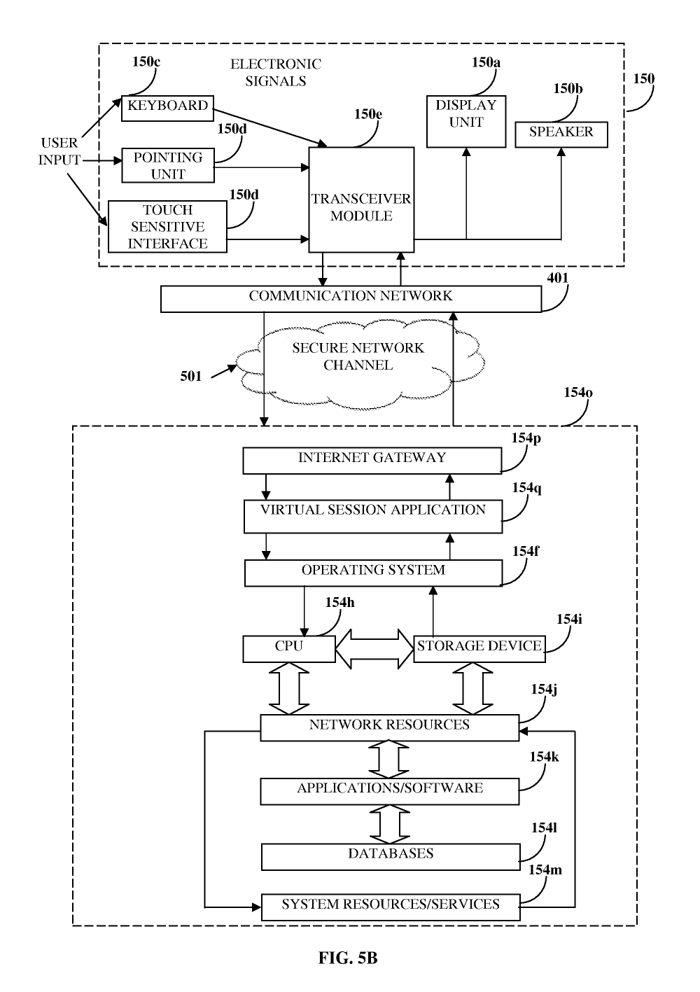

FIG. 5A schematically illustrates normal operation of the primary processing unit 154, when a user is physically operating on the primary processing unit 154 in real time. The primary processing unit 154 comprises input/output peripherals 154n to receive user input and provide a corresponding output. Examples of input peripheral units comprise keyboard 154c, a pointing unit 154d, etc. Examples of output peripheral units comprise a display 154a, speaker 154b, etc. The display 154a further comprises a touch sensitive interface 154e to receive user input entered using a stylus or touch. The user input received from each of the input peripheral units is in the form of electronic signals. The electronic signals are provided to the operating system 154f. The operating system 154f converts the electronic signals into system input signals. The system input signals instruct the central processing unit (CPU) 154h of the primary processing unit 154 to access various software applications 154k, databases 1541 and other system resources and services 154m available within the network 401 connected to the primary processing unit 154 to manipulate data, process the data and/or store the output data files that represent processed information. Data may comprise information existing in a hard disk 154i of the primary processing unit 154, input provided by the user or information stored in one or more networked devices.

The primary processing unit 154 is connected to a communication network 401, as illustrated in FIG. 5A. The communication network 401 is one of an internet, a local network, intranet, and any combination thereof. The communication network 401 provides access to various network resources 154j. The network resources 154j comprise information, hardware and software, etc., locally unavailable on the primary processing unit 154. The information is stored in one or more remotely accessible databases 1541. The software may comprise applications 154k residing on a remote mainframe computer system or server. The mainframe computer system is capable of handling performance intensive software applications 154k. Once a request is placed by the user of the primary processing unit 154 to retrieve a specific piece of information, the primary processing unit 154 retrieves the requested information and displays the information to the user through the display 154a and/or provides an audio output through the speaker 154b.

In an embodiment, the primary processing unit 154 can access system resources and /or services 154m that are specific for use by one or more users of the primary processing unit 154. The system resources and/or services 154m comprise sensitive data, encryption/decryption software, etc., providing permission to access within a specific boundary.

FIG. 5B illustrates the system for establishing a virtual session with a primary processing unit 154 using the mobile input/output device 150, acting as a captive dumb terminal of the primary processing unit 154. The output peripherals of the mobile input/output device 150 comprise a display unit 150a and a speaker 150b. The input peripherals of the mobile input/output device 150 comprise a keyboard 150c, a pointing unit 150d and a touch sensitive interface 150d integrated with the display unit 150a. The mobile input/output unit 150 may further comprise a microphone (not shown) for receiving an audio input and a camera for receiving a video input. User provides inputs in the form of keystrokes through the keyboard 150c, and point, click and drag operations through the pointing unit 150d and/or the stylus etc. User inputs represent at least a part of the information that the user intends to process using the primary processing unit 154. The user inputs are converted into electronic signals by the mobile input/output device 150. In one embodiment, the input peripherals convert the user input into electronic signals and provide the electronic signals to the transceiver module 150e of the mobile input/output device 150. The transceiver module 150e digitizes the electronic signals. The transceiver module 150e converts electronic signals into cellular transmission packets for transmission over a communication network 401. The communication networks may comprise public switched telephone network (PSTN) or another network such as Wi-Fi, third party wireless carriers etc. The cellular packets are transmitted over an existing cellular data transmission network through the transceiver module 150e. The transceiver module 150e utilizes a secure network channel 501 to securely transmit the cellular packets over the communication network 401. A secure network channel 501 employs secure communication protocols to provide a way to authenticate the primary processing unit 154 and the mobile input/output device 150 on the communication network 401, for example internet, and to protect the confidentiality of communication between the primary processing unit 154 and the mobile input/output device 150.

The primary processing unit 154 receives the transmitted cellular packets through an internet gateway 154p. An internet gateway 154p is a network connection point, equipped to interface with another network that uses different protocols for communication. The virtual session application 154q on the primary processing unit 154 detects cellular packets transmitted by the mobile input/output device 150. Upon receiving one or more cellular packets, the virtual session application 154q issues commands to the primary processing unit 154 to disable input/output ports through which the input/output peripherals are connected to the primary processing unit 154. The virtual session application 154q effectively disconnects the input/output peripherals from the primary processing unit 154 and replaces them with the input/output peripherals of the mobile input/output device 150.

The cellular packets received from the mobile input/output device 150 are converted into electronic signals and translated into system input signals by the virtual session application 154q. The system input signals are capable of being read by the primary processing unit 154. The user establishes a remote session with the primary processing unit 150 through the mobile input/output device 150. The mobile input/output device 150 establishes a virtual presence of the user at the primary processing unit 150. The system input signals provide instructions to the primary processing unit 154 to manipulate data, process the data, and store the data at the primary processing unit 154.

Processed information is obtained by processing the system input signals. The primary processing unit 154 may utilize one or more of network resources 154j, application software 154k, system resources and services 154m, and any combination thereof to obtain the processed information. The processed information is in the form of computer readable data files that can be stored in appropriate locations within one or more hard discs 154i of the primary processing unit 154. The virtual session application 154q running on the primary processing unit 154 translates the processed information into corresponding audio-visual signals. Although the primary processing unit 154 is hardwired to send these output signals to output peripheral units physically connected to the primary processing unit 154, the virtual session application 154q of the method and system disclosed herein supersedes this functionality and transmits the output audio-visual signals to the remote user's mobile input/output device 150 via the communication network 401.

The audio-visual signals are transmitted from the primary processing unit 154 to the mobile input/output device 150 over the communication network 401. The mobile input/output device 150 receives the audio-visual signals and provides output to the user through the output peripheral units. In one embodiment, the mobile input/output device 150 separates the audio-visual signals into audio and visual components. The audio component is provided to the speaker 150b and the visual component is provided to the display unit 150a. In another embodiment, the primary processing unit 154 may directly transmit audio and visual components over separate communication channels. The mobile input/output device 150 receives the audio and visual components and provides them to the display unit 150a and speaker 150b respectively.

In each embodiment shown above, the mobile input/output device 150 can function with a display unit 150a having a touch sensitive interface 150d where the display unit 150a displays a menu of options and a stylus is used to select at least one of the displayed options. With this embodiment, and depending on the applications that are desired by a user, the keyboard 150c and pointing unit 150d may not be needed to practice the method and system disclosed herein.

When a user can physically access the input and output peripherals of the primary processing unit 154, the user can view the display 154a and use the key board 154c, pointing unit 154d, or a touch sensitive interface 154e of the display 154a for receiving output and providing input respectively. The input/output peripherals are physically connected with the CPU 154h of the primary processing unit 154. Therefore, the user can view the display 154a, use the keyboard 154c and the pointing unit 154d (or touch sensitive interface 154e of the display 154a) to receive output and provide also provide an input. In the method and system disclosed herein, virtual presence of the user is created at the primary processing unit 154 using the input and output peripheral units of the mobile input/output device 150. The input and output peripheral units of the primary processing unit 150 are remotely connected via a third party carrier network, wherein the signals are transmitted and received using a commercially available transceiver module 150e.

The mobile input/output device 150 only needs to access the primary processing unit 154 for the remote user to virtually operate on the central processing unit (CPU) 154h of the primary processing unit 154. The reason for this is the primary processing unit 154 has large processing power, storage capacity and hard disk 154i containing all the software applications 154k and files, and is supported by a fixed line/wireless global communications network 401 for performing all of the various computing functions required by the user located remotely. Thus, with the method and system disclosed herein, by using a display unit 150a, keyboard 150c and a pointing unit 150d contained in the mobile input/output device 150, the user can virtually access and use his/her own primary processing unit 154 (office workstation or home desktop PC) for a session in real time from a remote location on the primary processing unit 154, without having to use any other “intelligent” mobile device or hardware, or have to pay for software application licenses (e.g., MS-Office), operating systems (e.g., Windows) or services such as land line based high capacity broadband internet service provider (ISP) service for internet. The only cost to a user will be the wireless communication charges for actual use of the cellular network 401 for the transmission of input and output signals.

In normal physical operation of the primary processing unit 154, the underlying operating systems like Windows® converts “raw” or analog user input signals (keystrokes or clicks via a pointing unit 150d) into system inputs for processing by the CPU 154h. Multiple resources available within a multiserver information system networked with the primary processing unit 154 often produce the final system output. The resources include software 154k, data files, and services 154m resident inside and/or outside the primary processing unit 154. The resources are invisible and unintelligible to the user. At the end of this complex process, audio-visual signals intelligible to the user are extracted from the final system output of the primary processing unit 154 (an e-mail in English language, or a video playing on a remote U-Tube server for example) and provided on the display 154a and speaker 154b physically connected to the primary processing unit 154 via cables.

The method and system disclosed herein effectively separates user interaction with the primary processing unit 154 from all system processing functions including data retrieval and storage. By transmitting electronic signals back and forth between the mobile input/output device 150 and the primary processing system 154, the user virtually returns to the primary processing unit 154, leaving the system processing function identical to the scenario wherein the user physically operates on the primary processing unit 154 thereby accessing available resources in real time. The mobile input/output device 150 serves as a substitute captive “dumb” peripheral of the primary processing unit 154.

The mobile input/output device 150 is not a separate and distinct computing device by itself and has limited specialized computing power. The computing power of the mobile/input output device 150 is limited due to the absence of a processor, capable of performing general purpose operations/computations. The mobile input/output device 150 establishes a communication link with the virtual session application 154q in the primary processing unit 154, transmits input electronic signals to the primary processing unit 154, receives audio-visual output signals from the primary processing unit 154, and renders the audio-visual signals as visual display and audio output on the display unit 150a and speaker 150b of the mobile input/output device 150, respectively. The mobile input/output device 150 does not comprise a permanent storage capability, compared to a mini-PC or PDA. With the method and system disclosed herein, all the computing power of the central processing unit (CPU) 154h, applications, files and services, e.g., high bandwidth internet and security services, of the primary processing unit 154 are used. Therefore, these resources are not duplicated in the mobile input/output device 150. The mobile input/output device 150 uses all the resources of the primary processing unit 154 remotely. The virtual session application 154q completely eliminates any need to compress data and program files, including .EXE and .COM files and to transmit such files via the communication network 401 to a wireless interface device with electronically programmable storage capacity. Instead of “pushing” data files to the remote user, the virtual session application 154q virtually brings back the remote user into the primary processing unit with the mobile input/output terminal providing a true virtual session with audio-visual output.

Disclosed herein is a new, lightweight, power efficient, inexpensive and portable electronic mobile input/output device 150 that can, via the virtual session application 154q, remotely access and securely use all the computing power of a primary processing unit 154, network resources 154j, applications and software 154k, databases 154l, and system resources and service 154m of the remote primary processing unit 154. The virtual session application 154q effectively turns the mobile input/output device 150 into a captive dumb terminal of the primary processing unit 154, wherein the mobile input/output device 150 provides comprehensive mobile computing functions and the highest level of user experience and security that cannot be fully obtained with currently available mobile devices or expensive mobile computing technologies, such as Citrix, which “push” pre-authorized program and data files on to an intelligent mobile device like a laptop PC or PDA with independent data processing and local storage capability. The method and system disclosed herein disclosed herein is a paradigm shift in mobile computing as it does not duplicate or substitute any system software or resources, nor simply provide a network connection to the primary processing unit 154 from another computer.

Additional advantages obtained are that the mobile input/output device 150 has a long battery life, is much less expensive and is very light in weight when compared to a laptop or tablet computer. What the method and system disclosed herein does that is new or unique is to effectively provide a mobile input/output device 150 of a remote user with access to all the computing resources and data that reside within the user's primary processing unit 154, virtually and securely.

The data file, software 154k or resources 154m secured behind a firewal of the primary processing unit 154 are not downloaded into the mobile input/output device 150. The mobile input/output device 150 does it have any capability to locally store data. Therefore, security issues that currently plague and severely restrict work-related mobile computing do not exist since data cannot be pushed on to, or downloaded into the mobile input/output device 150. Nothing within the primary processing unit 154 needs to be duplicated in the mobile input/output device 150, except for installation of the hardware and embedded software, required to allow the mobile input/output device 150 to interface with the primary processing unit 154. During operation, no separate internet service provider (ISP) charges or software licensing costs are incurred, including MS Windows, MS Office etc., and the only operating cost is the wireless data transmission cost charged by the carrier for actual usage which is similar to cellular telephone costs for transmission of input and output signal alone.

In accordance with the principles of the method and system disclosed herein, two embodiments of the mobile input/output device 150 are disclosed. One embodiment resembles the form factor of a cell phone or a personal digital assistant (PDA). However, the mobile input/output device 150 precludes all the functionalities of the cell phone or a PDA. Instead, the mobile input/output device 150 is extremely light and small and has only a small display unit 150a with a touch sensitive interface 150d and a detachable keyboard 150c, but no electronically programmable storage. The keyboard 150c is not required to be carried unless composing long e-mails, documents or heavy computing is contemplated. The on screen keyboard 150c accessible via the touch sensitive interface 150d may not be sufficient for providing large amount of input. This embodiment automatically includes cell phone functions because any audio-visual device is capable of voice, although not the other way around. The second embodiment resembles the form factor of a laptop version. The mobile input/output device 150 also precludes all the functionalities of the laptop. Instead, the mobile input/output device of this embodiment comprises a larger display unit 150a, built in keyboard 150b and a pointing unit 150d and all other peripheral connectivity (e.g., printer, fax, USB ports etc.), for high bandwidth usage like heavy work related computing such as ERP modules manipulating large databases 154l that impose limitations to existing mobile PC, PDA, etc. This embodiment is still much less expensive and is smaller and lighter than a traditional laptop, but is perfectly capable of giving the user better flexibility to do all office work (other than being in physical attendance in a meeting) from home, while traveling, or from another office or hotel, than a traditional laptop since the user is virtually operating on his/her primary processing unit 154 itself.

With the method and system disclosed herein remote access is obtained to all applications, all licensed software 154k, and all files, including the Window operating system and internet service 154m that reside on the primary processing unit 154, and all files continue to be saved and overwritten in the primary processing unit's 154 hard disk(s) 154i as the primary processing unit 154 continues to use the CPU 154h for processing, updating, networking and internet access. The method and system disclosed herein leverages the existing cellular or other third party carrier networks to provide a simulated (virtual) operation on the remote primary processing unit 154 via a mobile input/output device 150, thus using the same customized primary processing unit 154 on a small lightweight handheld device without sacrificing any processing power of the CPU 154h or the advantage of the fixed line high speed internet access (broadband).

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the database 154l, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes, such as those disclosed herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method for transmitting a user's input from a mobile input/output device to a primary processing unit to obtain output, wherein said primary processing unit receives said input, processes said received input to obtain said output, stores said output, and transmits audio-visual signals representing said output back to the mobile input/output device for transient display to said user, wherein said method comprises:
providing a virtual session application in said primary processing unit for creating virtual presence of said user in said primary processing unit, wherein said user remotely access said primary processing unit through said mobile input/output device;
providing an input by said user to said mobile input/output device, wherein said input is a digital translation of actions and analog inputs of said user, captured by the input units of the mobile input/output device;
converting said input to one or more electronic signals by said mobile input/output device;
transmitting said electronic signals from said mobile input/output device to said primary processing unit over a communication network;
receiving said transmitted electronic signals by said primary processing unit, wherein said received electronic signals are translated into system input signals by said virtual session application for manipulating, processing, and storing data at the primary processing unit;
processing said system input signals by the primary processing unit using one or more resources of the primary processing unit to obtain and store said output, wherein said resources include software and services accessible by the primary processing unit;
translating said output into audio-visual signals by said virtual session application;
transmitting said audio-visual signals from the primary processing unit to said mobile input/output device over said communication network by the virtual session application;
receiving said audio-visual signals and presenting said received audio-visual signals as one of an audio output, screen flashes, and a combination of both audio output and screen flashes at the mobile input/output device.
whereby said method of providing input at the mobile input/output device and presenting audio-visual output at said mobile input/output device by said virtual session application enables said user to virtually and securely access, and use said software, said services, said system resources, said data and network resources of said primary processing unit.

2. The method of claim 1, wherein said input units comprise one or more of a keyboard, a pointer unit, a camera, a microphone, and any combination thereof.

3. The method of claim 1, wherein said screen flashes are presented to said user using a display unit, wherein said display unit comprises a touch sensitive interface for receiving the information signals from the user through a pointer unit.

4. The method of claim 1, wherein said user is authorized to access said primary processing unit and perform pre-authorized operations, and wherein said primary processing unit authenticates said user prior to performing said pre-authorized operations.

5. A system for transmitting a user's input from a mobile input/output device to a primary processing unit to obtain output, wherein said primary processing unit receives said input, processes said received input to obtain said output, stores said output, and transmits audio-visual signals representing said output back to the mobile input/output device for display to said user, wherein said system comprises:
said mobile input/output device, wherein said mobile input/output device converts said input provided by said user to electronic signals and transmits said input to said primary processing unit, wherein the mobile input/output device comprises:
one or more input units for capturing and digitally translating actions and analog inputs of said user of said mobile input/output device into electronic signals;
a transceiver within the mobile input/output device for transmitting electronic signals to said primary processing unit and for receiving said audio-visual signals from said primary processing unit, over a communication network;
a processing unit at the mobile input/output device for rendering said received audio-visual signals into audio signals and visual signals;
a display unit for displaying said rendered video signals to said user; and
a speaker for presenting said rendered audio signals to the user as audio output at the mobile input/output device.
said primary processing unit, wherein said primary processing unit authenticates said user and processes said input received from the mobile input/output device, stores processed information, and provides access to a plurality of local software, local system resources, local services, and network resources, and wherein said primary processing unit is connected to one or more servers for accessing information stored in said servers; and
a virtual session application residing in said primary processing unit for creating virtual presence of said user in said primary processing unit, wherein said virtual session application converts said remote user inputs into system inputs for processing by said primary processing unit, and converts said processed information into audio-visual signals for transmission to said mobile input/output device for display.

6. The system of claim 5, wherein the communication network is one of a wireless carrier network, a wireless local area network, a Wi-Fi connection, a Wi-Max connection and a publicly available “hotspot”, wherein the third party communication network provides an internet service.

7. The system of claim 5, wherein the communication network is one of a land line based broadband from an Internet service provider and a local area network providing Internet service via land line.

8. The system of claim 5, wherein the display unit is an LCD screen comprising a touch sensitive interface.

9. The system of claim 5, wherein the mobile input/output device comprises one of an external keyboard, an on-screen keyboard, and a combination of an external keyboard and an on-screen keyboard, and further wherein the mobile input/output device comprises a mouse, a pointing unit, and a combination of a mouse and a pointing unit.

10. The system of claim 5, wherein the mobile input/output device is a stand-alone mobile input/output device integratable with one of said cell phone and said personal digital assistant.

11. The system of claim 5, wherein the mobile input/output device is integrated with a laptop personal computer, and is accessed as an independent software application.

12. The system of claim 5, wherein said user is authorized to access said primary processing unit and perform pre-authorized operations, and wherein said primary processing unit authenticates said user prior to performing said pre-authorized operations.

13. The system of claim 5, wherein the primary processing unit is a personal computer.

14. The system of claim 5, wherein the primary processing unit is networked with a plurality of personal computers and said servers in one of a local area network configuration and a wide area network configuration.

15. The system of claim 12, wherein the primary processing unit is a network server providing pre-authorized secure access to a multi-server system comprising said local system resources and a plurality of data centers, wherein said pre-authorized secure access is provided through a secure intra-net, and wherein a firewall and a plurality of security protocols provide said pre-authorized secure access to said multi-server system.

16. The system of claim 5, wherein the primary processing unit runs one of a Windows operating system, a Mac operating system, a Unix operating system, and a Linux operating system.

17. The system of claim 5, wherein the primary processing unit is an integral part of a multi-server system, further wherein the primary processing unit is networked to operate on applications and databases within said multi-server system.

18. The system of claim 5, wherein the primary processing unit manipulates said software applications, said system services, said custom configurations, and the information residing in one or more remote data centers, in addition to the information residing locally in hard disk of the primary processing unit.

19. The system of claim 5, wherein the primary processing unit maintains uninterrupted connection to one of said servers that provide Internet service.

20. The system of claim 5, wherein the primary processing unit is connected with one or more shared peripherals, wherein the user of the mobile input/output device remotely accesses said one or more shared peripherals.

21. The system of claim 5, wherein the primary processing unit and the mobile input/output device is connected through an intermediating server, wherein said intermediating server performs switching functions and manages connections between multiple pairs of primary processing unit and mobile input/output device.

22. The system of claim 5, wherein the primary processing unit runs a virtual private communication network host and wherein the mobile input/output device runs a corresponding client.

23. The system of claim 5, wherein the communication between the primary processing unit and the mobile input/output device is routed through Internet.

24. The system of claim 5, wherein the mobile input/output device further comprises a basic operating system, and where said basic operating system and said processing unit are specifically designed and configured to exclusively drive input and output peripherals of the mobile input/output device and one of wireless connectivity and landline connectivity.

25. The system of claim 24, wherein the basic operating system is embedded within the processing unit of the mobile input/output device, without any capability of reading unauthorized third party software and programs, wherein said third party software and programs comprise bugs, viruses, spyware, cookies, and wherein said mobile input/output device cannot download and locally store said third party software and programs.

26. The system of claim 5, wherein the mobile input/output device is completely captive and stateless without a locally resident operating system, and wherein said mobile input/output device is remotely booted by a host server at the primary processing unit during authorized usage for providing secure access.

27. The system of claim 5, wherein the mobile input/output device comprises multiple form factors based on user preference, features, functionality and custom configuration including detachability of peripherals.
